(19) United States
(12) Patent Application Publication
(10) Pub. No.: US 2023/0148311 A1
(43) Pub. Date: May 11, 2023

(54) Uses For Supramolecular Host Guest Product Concentrators In The Oil Field

(71) Applicant: Halliburton Energy Services, Inc., Houston, TX (US)

(72) Inventors: Jay Deville, Houston, TX (US); Enrique Antonio Reyes, Houston, TX (US); Antonio Recio, Houston, TX (US); William W. Shumway, Houston, TX (US); Ronald Bosch, Houston, TX (US)

(73) Assignee: Halliburton Energy Services, Inc., Houston, TX (US)

(21) Appl. No.: 17/876,432

(22) Filed: Jul. 28, 2022

Related U.S. Application Data
(60) Provisional application No. 63/276,941, filed on Nov. 8, 2021.

(51) Int. Cl. C09K 8/588

(52) U.S. Cl. CPC C09K 8/588

(57) ABSTRACT

A method may include: introducing a treatment fluid into a stream, the treatment fluid comprising: a base fluid and a supramolecular host guest product, wherein the supramolecular host guest product comprises a treatment fluid additive and a supramolecular host molecule, wherein the supramolecular host molecule is not covalently bonded to the treatment fluid additive.

### BACKGROUND

In the oil field, treatment fluids may be used for a variety of applications including drilling, casing, primary cementing, remedial cementing, hydraulic fracturing, gravel packing, frac-packing, solids control, wellbore and well remediation, swabbing, chemical injection, chemical flooding for enhanced oil recovery, steam injection, and production enhancement, among other wellbore operations. Treatments fluids often contain additives which impart specific properties to the treatment fluid such as corrosion inhibition, asphaltene and paraffin prevention or remediation, H2S prevention, lubrication, flocculation prevention, among other properties. The additives typically provide beneficial properties at the interface of the treatment fluid and a surface that is not the treatment fluid such as an interface between the wellbore walls, downhole equipment, and particles within the treatment fluid. However, the additives in treatment fluids are often dispersed in the bulk phase of the treatment fluid where the additives may not have a beneficial effect. Treatment fluids are oftentimes formulated with excess additives to ensure that an adequate concentration of the additive at an interface of interest is maintained.

### BRIEF DESCRIPTION OF THE DRAWINGS

These drawings illustrate certain aspects of some of the embodiments of the present disclosure and should not be used to limit or define the disclosure.

FIG. 1 illustrates a drilling assembly in accordance with some embodiments of the present disclosure.

FIG. 2 illustrates a schematic view of a well system utilized for hydraulic fracturing.

FIG. 3 illustrates a schematic view of a well system utilized to place conformance treatment fluids and/or water shut-off fluids in a wellbore, the near wellbore area, or the far wellbore area.

### DETAILED DESCRIPTION

Disclosed herein are methods, compositions, and systems for treatment of wellbores using treatment fluids comprising a supramolecular host guest product. Treatment fluids which are formulated with supramolecular host guest products may facilitate concentration of the treatment fluid additives at an interface of interest such that treatment fluid is more effective. Treatment fluids may include a base fluid and a supramolecular host guest product containing a treatment fluid additive. In some examples, utilizing supramolecular host guest products may allow for a lower concentration of additives to be utilized as compared to a treatment fluid which does not contain supramolecular host guest products. As used herein, supramolecular host guest products are molecular complexes that are composed of two or more molecules or ions that are bound by forces other than full covalent bonds. Supramolecular host guest products may include a treatment fluid additive (guest) and a supramolecular host molecule, wherein the host and guest are not covalently bonded, to the treatment fluid additive and facilitates the transport of the treatment fluid additive within the bulk phase of the treatment fluid to an interface.

Supramolecular host guest products may comprise a supramolecular host molecule and treatment fluid additive (guest) where the supramolecular host molecule may arrange in a variety of structures with the treatment fluid additive. Non-limiting examples of these structures may include micelles, liposomes, nanostructures, and nanobubbles. Examples of supramolecular host molecules may include crown ethers, lariat ethers, cavitands, cryptands, rotaxanes, catenanes, or any combination thereof. Cavitands may be cavity containing molecules which are capable of host guest interactions with molecules of a similar size and shape. Examples of cavitands may include cyclodextrins, calixarenes, pillararenes, and curcurbiturils. Calixarenes may be three dimensional host structures which may trap treatment fluid additives. In some examples calixarenes may deliver treatment fluid additives to an interface where they may be beneficial to an oil field operation. Cryptands may be cation specific molecules with covalently bound tri-valent and multi-valent binding sites which may assembled in a cyclic or polycyclic structure. Examples of cryptands may include polyetheramines and 1,10-diaza-4,7,13,16,21,24-hexaoxabicyclo[8.8.8]hexacosane. Examples of cations for complexation may include ammonium (NH4+), lanthanoids, alkali metals, and alkaline earth metals. Rotaxanes may be a rod-like molecule wherein a portion of the rod is enclosed by a ring-like structure. The ends of the rod-like portion of the molecule may further comprise oversized end-groups which entrap the ring. Catenanes may be structured as two cyclic compounds which may not be covalently bonded, however, covalent bond cleavage is required for disruption of the supramolecular structure. In some examples, crown ethers may selectively host specific ions depending on their size. In further examples, 18 crown 6 may selectively host potassium while 15 crown 5 may host sodium and 12 crown 4 may host lithium. Additional suitable supramolecular host molecules may further comprise modified silica nanoparticles, modified clay nanoparticles, modified graphene nanoparticles, or modified nanocellulose nanoparticles. In some examples, silica-encapsulated molecular organic frameworks may be used as supramolecular host molecules.

Supramolecular host guest products may include a treatment fluid additive (guest) which may include, without limitation, small charged species, low molecular-weight aliphatic moieties, or polar organic functional groups such as amidoamines, amines, amides, glycols, silicates, polymers (e.g.: polyacrylamide, partially hydrolyzed polyacrylamide (“PHPA”), polyvinylpyrrolidone (“PVP”)), esters, ethers, quaternized alkyl or aryl molecules, conjugates or derivatized macromolecules, oxidizer or oxidizing agents, reducer or reducing agents, metal (oxy)anion salts where the metal is a multivalent (n) cation (n=+2, +3, +4, +5, +6, +7) and the anion is a halide, sulfur or selenium, nitrogen or phosphorous; and the like. In some examples, more than one treatment fluid additives may be included. In further examples the treatment fluid additives may include salts, acids, fluid loss control additives, gas, foamers, corrosion inhibitors, scale inhibitors, catalysts, clay control agents, biocides, friction reducers, iron control agent, antifoam agents, bridging agents, dispersants, hydrogen sulfide (“H2S”) scavengers, carbon dioxide (“CO2”) scavengers, oxygen scavengers, lubricants, viscosifiers, breakers, weighting agents, inert solids, emulsifiers, resins, docking agents, activators, gelling agents, interfacial tension suppressants, dispersants, chemical degradation suppressants, synthetic polymer breakers, polysaccharide-based polymer breakers, dissolution aids, emulsion thinner, emulsion thickener, surfactants, lost circulation additives, pH control additive, buffers, crosslinkers, stabilizers, chelating agents, mutual solvent, oxidizers, reducers, consolidating agent, complexing agent, particulate materials and any combination thereof.

Treatment fluids may include a base fluid and a supramolecular host guest product comprising a treatment fluid additive. In some examples the supramolecular host guest products may be synthesized in polar and/or non-polar solvents. In further examples, a polar solvent may include water, and a non-polar solvent may include oil, mineral oil, or other non-water-miscible mediums. The treatment fluid may be prepared using any suitable method. For example, a base fluid and a supramolecular host guest product may be mixed to form the treatment fluid which may then be introduced into a wellbore, production system, or refinery process stream. The mixing process achieved by any suitable method and/or equipment. In some examples, blenders, mixers, stirrers, and the like, may be utilized to form the treatment fluid. Additional methods of mixing may include sequentially adding components while performing batch mixing or continuous (“on-the-fly”) blending operations, utilizing liquid additive pumps (“LA pump”) to meter out specific volumes of given components, and/or slip-streaming either of the additives and/or the supramolecular host guest product into the base fluid. In some examples the process of preparing the treatment fluid may take place at the well site location, production storage location, or a refinery location while in other examples the treatment fluid may be prepared, either in whole or in part, at an offsite location and then transported to location to be used.

Base fluids may include, without limitation, oleaginous fluids, synthetic fluids, aqueous fluids, and combinations thereof. In some examples, the treatment fluids may be in the form of an emulsion. An example of a suitable emulsion may be in the form of an invert emulsion that comprises an oleaginous continuous phase and a non-oleaginous discontinuous phase. Another example of a suitable oilfield emulsion may be in the form of a direct emulsion that comprises a non-oleaginous continuous phase and an oleaginous discontinuous phase. Whether invert or direct emulsion, the ratio of the continuous phase to discontinuous phase in the oilfield emulsion, for example, may be in the range of 20:80 v/v CDR (continuous phase to discontinuous phase ratio) to 99:1 v/v CDR or, alternatively 20:80 v/v CDR to 90:10 v/v CDR or, alternatively 20:80 v/v CDR to 50:50 v/v CDR. The continuous phase (e.g., non-oleaginous phase) can be any suitable vol % of the oilfield emulsion. For example, the continuous phase can be about 1 vol % to about 99 vol % of the oilfield emulsion, about 10 vol % to about 50 vol %, or about 1 vol % or less, or about 2 vol %, 3, 4, 5, 6, 8, 10, 12, 14, 16, 18, 20, 25, 30, 35, 40, 45, 50, 55, 60, 65, 70, 75, 80, 85, 90, 91, 92, 93, 94, 95, 96, 97, 98, about 99 vol %, or any ranges therebetween in the oilfield emulsion.

Further examples of base fluids may include, without limitation, aqueous fluids, non-aqueous fluids, slickwater fluids, aqueous gels, viscoelastic surfactant gels, and foamed gels. Examples of suitable aqueous fluids may include fresh water, saltwater, brine, seawater, and/or any other aqueous fluid. Examples of suitable non-aqueous fluids may include organic liquids, such as hydrocarbons (e.g., kerosene, xylene, toluene, or diesel), oils (e.g., mineral oils or synthetic oils), esters, and any combination thereof. Suitable slick-water fluids may generally be prepared by addition of small concentrations of polymers to water to produce what is known in the art as “slick-water.” Some suitable polymers may include polyacrylamides. In other examples, polymers may polymers may comprise any of a variety of monomeric units, including acrylamide, acrylic acid, 2-acrylamido-2-methylpropane sulfonic acid, N,N-dimethylacrylamide, vinyl sulfonic acid, N-vinyl acetamide, N-vinyl formamide, itaconic acid, methacrylic acid, acrylic acid esters, methacrylic acid esters and combinations thereof. The term “polymer” in the context of a friction reducing polymer, refers to any form of the friction reducing polymer including acid, base, zwitterionic, and salt forms of the friction reducing polymer. Suitable aqueous gels may generally comprise an aqueous fluid and one or more gelling agents. Some gels may include polyacrylamides, polysaccharides, celluloses, xanthan, diutans, and combinations thereof. The gels may be present in any amount suitable to form a gel with desired properties. In some examples, a gel loading for a slick-water fluid may be about 10 liters per thousand liters (“LPT”) or less. In some examples a slick-water additive, which may include a gelling agent, a polymer, or combinations thereof, may be present in an amount of about 0.5 LPT to about 10 LPT. In other examples the slick-water additive may be included in an amount of about 0.5 LPT to about 1 about 1 LPT to about 2 LPT, about 2 LPT to about 3 LPT, about 3 LPT to about 4 LPT, about 4 LPT to about 5 LPT, about 5 LPT to about 6 LPT, about 6 to about 7 LPT, about 7 ITT to about 8 LPT, about 8 LPT to about 9 LPT, about 9 LPT to about 10 LPT, or any combination thereof.

In some examples, the treatment fluid may be an emulsion or a foamed fluid. Suitable emulsions may be comprised of two immiscible liquids such as an aqueous fluid or gelled fluid and a hydrocarbon. Foams may be created by the addition of a gas, such as carbon dioxide or nitrogen; or alternatively halocarbons such as freons, freon substitutes and alternatives, or natural or liquefied natural gas and. Additionally, the base fluid may be an aqueous gel comprised of an aqueous fluid, a gelling agent for gelling the aqueous fluid and increasing its viscosity, and, optionally, a crosslinking agent for crosslinking the gel and further increasing the viscosity of the fluid. The increased viscosity of the gelled, or gelled and crosslinked, treatment fluid, inter glia, may reduce fluid loss and may allow the base fluid transport significant quantities of suspended particulates.

The foregoing treatment fluids may be used for any operation that impacts or contacts the wellbore environment, wellbore equipment, near wellbore environment, or subterranean formation. In a non-limiting example, the application for treatment fluids containing supramolecular host guest products may include operations such as drilling, casing, primary cementing, wellbore completion, filtercake damage removal, drilling fluid damage remediation, remedial cementing, hydraulic fracturing, hydraulic refracturing, wellbore remediation, water shutoff operations, swabbing, chemical injection, chemical flooding for enhanced oil recovery, steam injection, refinery operations, fluid separation operations, production enhancement, circulating, formation stabilization, casing, primary cementing, remedial cementing, acid fracturing, matrix acid jobs, logging, well testing, corrosion inhibition, water and chemical flooding for enhanced oil recovery, steam injection, production workovers, and the removal or inhibition of scale, salt, asphaltenes, paraffin, and combinations thereof.

In some examples, supramolecular host guest products may be used to improve the efficiency of lubricants used during a drilling process. Drilling fluids such as drilling mud may be circulated through the drilling system in order to remove rock cuttings and reduce wear and damage to the drilling equipment. In some examples, the drilling fluid may be circulated through the drilling system while drilling is actively occurring (e.g.: while the drill bit and drill string are extending a wellbore through a subterranean formation). In other examples the drilling fluid may be circulated through the system while the drill bit is stationary, or even while the drilling equipment is being removed from the wellbore. Lubricants may be incorporated into a drilling fluid in order to reduce the torque and drag associated with metal-on-metal friction which may occur between the drill string and the casing, as well as metal-on-formation friction which may occur between the drill string and/or drill bit and the subterranean formation. The interface between the drill string or drill bit and the casing or subterranean formation is the surface area at which the lubricants may be desired to operate. In drilling fluids which do not contain supramolecular host guest products, lubricants may be blended with a drilling mud or drilling fluid and dispersed throughout the bulk drilling fluid phase which may result in only a portion of the lubricants actively contacting the aforementioned frictional interfaces instead of collecting at the frictional interfaces. As such, the lubricant which is present in the bulk drilling fluid does not provide sufficient friction reduction at the frictional interface. As a result, there may be a lower effective concentration of the lubricants at the interfaces.

A variety of liquid lubricants may be used including oils of various origins (e.g.: soybean, vegetable, etc.), fatty esters, sulfurized compounds such as sulfurized olefins, fatty acids, fatty ethers, fatty poly-ethers, and fatty amides. In some examples, lubricants may include sulfides and disulfides of lead, arsenic, antimony, bismuth, zinc, iron, cadmium, copper, molybdenum, mercury, zinc dialkyl dithiophosphate, bismuth dialkyl dithiophosphate, tungsten disulfide, a mixture of micronized graphite and micronized metal disulfide, and any combination thereof. In some examples the micronized metal disulfides may include tungsten disulfide, molybdenum disulfide, bismuth disulfide, lead disulfide, arsenic disulfide, zinc disulfide, iron disulfide, cadmium disulfide, copper disulfide, mercury disulfide, and any combination thereof. Treatment additives such as liquid lubricants may be present in a drilling mud or a wellbore treatment fluid in any suitable amount. In some embodiments the liquid lubricants may be present in an amount from about 0.1% by volume to about 3% by volume. In further examples, the liquid lubricants may be present in an amount from about 0.1% by volume to about 0.25% by volume, about 0.25% by volume to about 0.5% by volume, about 0.5% by volume to about 0.75% by volume, about 0.75% by volume to about 1% by volume, about 1% by volume to about 1.5% by volume, about 1.5% by volume to about 2% by volume, about 2% by volume to about 2.5% by volume, about 2.5% by volume to about 3% by volume, about 0.1% by volume to about 1% by volume, about 0.1% by volume to about 0.5% by volume, about 0.1% by volume to about 0.75% by volume, or any ranges in between. In other examples, the liquid lubricants may be present in an amount from about 0.1 wt % to about 3 wt %. In further examples, the liquid lubricants may be present in an amount from about 0.1 wt % to about 0.25 wt %, about 0.25 wt % to about 0.5 wt %, about 0.5 wt % to about 0.75 wt %, about 0.75 wt % to about 1 wt %, about 1 wt % to about 1.5 wt %, about 1.5 wt % to about 2 wt %, about 2 wt % to about 2.5 wt %, about 2.5 wt % to about 3 wt %, about 0.1 wt % to about 1 wt %, about 0.1 wt % to about 0.5 wt %, about 0.1 wt % to about 0.75 wt %, or any ranges in between.

Supramolecular host guest products may also be used to improve the efficiency and efficacy of shale inhibitors during subterranean wellbore operations. The related operations may include utilizing water-based treatment fluids for drilling, hydraulic fracturing, workovers, chemical flushes, and chemical treatments. Shale inhibitors may be included in the supramolecular host guest products. Shale inhibitors may be used to prevent swelling and dispersion of formation clays during subterranean wellbore operations involving water-based fluids. In treatment fluids which do not contain supramolecular host guest products, shale inhibitors may be included as a treatment fluid additive and may be dispersed throughout the bulk treatment fluid. As such, the concentration of the shale inhibitor may be increased to ensure contact with the formation interface of the subterranean formation and/or the drill cuttings. Including a shale inhibitor in the supramolecular host guest product may increase the effective concentration of the shale inhibitor at key areas, which may include the formation interface. The inhibition performance may be improved by targeting the shale inhibitor to the wellbore wall (e.g.: the formation face of the subterranean formation) and rock cuttings. Additionally, the supramolecular host guest product may be small enough to penetrate into the porous medium of the shale formation through the wellbore wall or the interface of the subterranean formation which may improve the stability of the subterranean formation matrix. In some examples, 18 crown 6 may be used in water-based drilling fluid along with potassium to reduce or prevent swelling and dispersion of formation clays during drilling operations. In other examples, 18 crown 6 may host potassium which may be used in a direct emulsion fluid. In further examples, the hosted potassium may remain the internal oil phase until it reaches the formation clay.

Shale inhibitor chemistries may include small molecule amines, glycols, silicates and polymers such as polyacrylamides, PHPA, and PVP. Treatment additives such as shale inhibitors may be present in a drilling mud or a wellbore treatment fluid in any suitable amount. In some embodiments the shale inhibitors may be present in an amount from about 0.1% by volume to about 3% by volume. In further examples, the shale inhibitors may be present in an amount from about 0.1% by volume to about 0.25% by volume, about 0.25% by volume to about 0.5% by volume, about 0.5% by volume to about 0.75% by volume, about 0.75% by volume to about 1% by volume, about 1% by volume to about 1.5% by volume, about 1.5% by volume to about 2% by volume, about 2% by volume to about 2.5% by volume, about 2.5% by volume to about 3% by volume, about 0.1% by volume to about 1% by volume, about 0.1% by volume to about 0.5% by volume, about 0.1% by volume to about 0.75% by volume, or any ranges in between. In other examples, the shale inhibitors may be present in an amount from about 0.1 wt % to about 3 wt %. In further examples, the shale inhibitors may be present in an amount from about 0.1 wt % to about 0.25 wt %, about 0.25 wt % to about 0.5 wt %, about 0.5 wt % to about 0.75 wt %, about 0.75 wt % to about 1 wt %, about 1 wt % to about 1.5 wt %, about 1.5 wt % to about 2 wt %, about 2 wt % to about 2.5 wt %, about 2.5 wt % to about 3 wt %, about 0.1 wt % to about 1 wt %, about 0.1 wt % to about 0.5 wt %, about 0.1 wt % to about 0.75 wt %, or any ranges in between.

Supramolecular host guest products may be included in treatment fluids such as stimulation fluids. In some examples, the supramolecular host guest products may be included in the carrier fluid portion of a stimulation fluid. In other examples, the stimulation fluids may comprise a base fluid, supramolecular host guest product, and optionally one or more of a water-soluble polymer, a surfactant, an inorganic material, or a combination thereof. Stimulation fluids may include a supramolecular host guest product which includes friction reducers, viscosifiers/gelling agents, penetrating aids, non-emulsifiers, emulsifiers, demulsifiers, flowback aids, wettability modifiers, dissolution aids, corrosion inhibitors, clay control additives, fines control additives, scale prevention additives, foaming agents, defoaming agents, foam prevention additives, and combinations thereof. The stimulation fluids may be applicable to stimulation operations in conventional and unconventional reservoirs. In some examples, calixarenes may host long chain fatty amines or quaternary ammonium cations which may be mixed into either a water or a brine to form a treatment fluid to reduce or inhibit corrosion of metallic elements in wellbore applications. In further examples, the corrosion reducing treatment fluid may be included in stimulation fluids, drilling fluids, workover fluids, completion fluids, or any combination thereof.

Treatment fluids, including but not limited to stimulation fluids, may include a treatment fluid additive (guest) such as small charged species, low molecular-weight aliphatic moieties, and polar organic functional groups (ie, amidoamines, amines, amides, esters, ethers, etc.). The treatment fluids may include combinations of supramolecular host guest products which may be present in any suitable amount. For example, the supramolecular host guest products which includes a treatment fluid additive may be present in the treatment fluid in an amount ranging from about 0.01 wt % to about 99.99 wt %. The treatment fluid additive may also be present in the supramolecular host guest product in an amount ranging from about 0.01 wt % to about 99.99 wt %. Alternatively in some applications, the treatment fluid additive may be present in the treatment fluid in an amount ranging from about 5 wt % to about 95 wt %. In some examples, the treatment fluid additive may be present in the treatment fluid in an amount ranging from about 5 wt % to about 15 wt %, about 15 wt % to about 25 wt %, about 25 wt % to about 35 wt %, about 35 wt % to about 45 wt %, about 45 wt % to about 55 wt %, about 55 wt % to about 65 wt %, about 65 wt % to about 75 wt %, about 75 wt % to about 85 wt %, about 85 wt % to about 95 wt %, or any ranges in between. The treatment fluid additive may also be present in the supramolecular host guest product in an amount ranging from about 5 wt % to about 95 wt %. In some examples, the treatment fluid additive may be present in the supramolecular host guest product in an amount ranging from about 5 wt % to about 15 wt %, about 15 wt % to about 25 wt %, about 25 wt % to about 35 wt %, about 35 wt % to about 45 wt %, about 45 wt % to about 55 wt %, about 55 wt % to about 65 wt %, about 65 wt % to about 75 wt %, about 75 wt % to about 85 wt %, about 85 wt % to about 95 wt %, or any ranges in between. In other examples, the treatment fluid additive may be present in the treatment fluid in an amount ranging from about 15 wt % to about 75 wt %. The treatment fluid additive may also be present in the supramolecular host guest product in an amount ranging from about 15 wt % to about 75 wt %.

The supramolecular host molecule may be present in the treatment fluid in any suitable amount. For example, the supramolecular host molecule may be present in the treatment fluid in an amount ranging from about 0.01 wt % to about 99.99 wt %. The supramolecular host molecule may also be present in the supramolecular host guest product in an amount ranging from about 0.01 wt % to about 99.99 wt %. Alternatively in some applications, the supramolecular host molecule may be present in the treatment fluid in an amount ranging from about 5 wt % to about 95 wt %. In some examples, the supramolecular host molecule may be present in the treatment fluid in an amount ranging from about 5 wt % to about 15 wt %, about 15 wt % to about 25 wt %, about 25 wt % to about 35 wt %, about 35 wt % to about 45 wt %, about 45 wt % to about 55 wt %, about 55 wt % to about 65 wt %, about 65 wt % to about 75 wt %, about 75 wt % to about 85 wt %, about 85 wt % to about 95 wt %, or any ranges in between. The supramolecular host molecule may also be present in the supramolecular host guest product in an amount ranging from about 5 wt % to about 95 wt %. In some examples, the supramolecular host molecule may be present in the supramolecular host guest product in an amount ranging from about 5 wt % to about 15 wt %, about 15 wt % to about 25 wt %, about 25 wt % to about 35 wt %, about 35 wt % to about 45 wt %, about 45 wt % to about 55 wt %, about 55 wt % to about 65 wt %, about 65 wt % to about 75 wt %, about 75 wt % to about 85 wt %, about 85 wt % to about 95 wt %, or any ranges in between. In other examples, the supramolecular host molecule may be present in the treatment fluid in an amount ranging from about 15 wt % to about 75 wt %. The supramolecular host molecule may also be present in the supramolecular host guest product in an amount ranging from about 15 wt % to about 75 wt %.

In some examples, supramolecular host guest products may allow for targeted solids control for reservoir consolidation. In further examples, solids control may be utilized to restrict the production of proppant that is injected into a reservoir during a hydraulic fracturing operation, gravel packing operation, or a frac packing operation. In other examples, the natural reservoir rock or subterranean formation may itself be unconsolidated such that the pressure drop from the reservoir to the wellbore results in the production of clastic material and/or non-fluid reservoir materials. In such scenarios, resins and other reservoir consolidation chemistries may be used to reduce and/or prevent the production of formation fines, fine generated from proppant, gravel, pebbles, solid particulates, or non-fluid reservoir material. In further examples, the resins and other reservoir consolidation chemistries may utilize an activation package along with a supramolecular host guest product. In some examples, a resin may flash set if it comes in contact with water. In further examples, a 4 angstrom molecular sieve may be used to trap specific molecules, such as water. The use of a molecular sieve to host water molecules may allow for a resin to set without the use of a water-based fluid.

In some examples, supramolecular host guest products may further be used to assist in the isolation of water producing zones of a wellbore. When hydrocarbons are produced from wells that penetrate hydrocarbon producing formations, water often accompanies the hydrocarbons, particularly as the wells mature in time. The water can be the result of a water-bearing zone communicated with the hydrocarbon producing formations or zones by fractures, high permeability streaks and the like, or the water can be caused by a variety of other occurrences which are well known to those skilled in the art, such as water coning, water cresting, bottom water, channeling at the wellbore, etc. A variety of techniques have been used to reduce the production of undesired water. Generally, these techniques involve the placement of a material in a wellbore penetrating a water-zone portion of a subterranean formation that may prevent or control the flow of water into the wellbore. The techniques used to place these materials are referred to herein as “conformance techniques” or “conformance treatments.” Some techniques involve the injection of particulates, foams, gels, sealants, resin systems, or blocking polymers (e.g., crosslinked polymer compositions) into the subterranean formation so as to plug off the water-bearing zones. Water shutoff fluids may include a treatment fluid composed of a water-soluble polymer, a surfactant, an inorganic material, or combinations thereof that may function as relative permeability modifiers or disproportionate permeability modifiers in the absence of viscosification or crosslinking. Further examples of water shutoff fluids may include treatment fluids which may include hydrogels capable of at least partially sealing at least a portion of the reservoir and/or near wellbore area. These treatment fluids may include water-soluble polymers and metal-, or organic-crosslinkers. Additionally, the treatment fluids described above may also be applicable to gas shutoff in a subterranean formation, liquid diversion, or fluid loss control. In some examples, fluid loss control may be beneficial during drilling, completions, hydraulic fracturing, or workover operations.

Treatment fluids, including but not limited to water shutoff fluids used in water shutoff operations and conformance operations, may include a treatment fluid additive (guest) such as small charged species, low molecular-weight aliphatic moieties, and polar organic functional groups (ie, amidoamines, amines, amides, esters, ethers, etc.). The treatment fluids may include combinations of supramolecular host guest products which may be present in any suitable amount. For example, the supramolecular host guest products which includes a treatment fluid additive may be present in the treatment fluid in an amount ranging from about 0.01 wt % to about 99.99 wt %. The treatment fluid additive may also be present in the supramolecular host guest product in an amount ranging from about 0.01 wt % to about 99.99 wt %. Alternatively in some applications, the treatment fluid additive may be present in the treatment fluid in an amount ranging from about 5 wt % to about 95 wt %. In some examples, the treatment fluid additive may be present in the treatment fluid in an amount ranging from about 5 wt % to about 15 wt %, about 15 wt % to about 25 wt %, about 25 wt % to about 35 wt %, about 35 wt % to about 45 wt %, about 45 wt % to about 55 wt %, about 55 wt % to about 65 wt %, about 65 wt % to about 75 wt %, about 75 wt % to about 85 wt %, about 85 wt % to about 95 wt %, or any ranges in between. The treatment fluid additive may also be present in the supramolecular host guest product in an amount ranging from about 5 wt % to about 95 wt %. In some examples, the treatment fluid additive may be present in the supramolecular host guest product in an amount ranging from about 5 wt % to about 15 wt %, about 15 wt % to about 25 wt %, about 25 wt % to about 35 wt %, about 35 wt % to about 45 wt %, about 45 wt % to about 55 wt %, about 55 wt % to about 65 wt %, about 65 wt % to about 75 wt %, about 75 wt % to about 85 wt %, about 85 wt % to about 95 wt %, or any ranges in between. In other examples, the treatment fluid additive may be present in the treatment fluid in an amount ranging from about 15 wt % to about 75 wt %. The treatment fluid additive may also be present in the supramolecular host guest product in an amount ranging from about 15 wt % to about 75 wt %.

The supramolecular host molecule may be present in the treatment fluid in any suitable amount. For example, the supramolecular host molecule may be present in the treatment fluid in an amount ranging from about 0.01 wt % to about 99.99 wt %. The supramolecular host molecule may also be present in the supramolecular host guest product in an amount ranging from about 0.01 wt % to about 99.99 wt %. Alternatively in some applications, the supramolecular host molecule may be present in the treatment fluid in an amount ranging from about 5 wt % to about 95 wt %. In some examples, the supramolecular host molecule may be present in the treatment fluid in an amount ranging from about 5 wt % to about 15 wt %, about 15 wt % to about 25 wt %, about 25 wt % to about 35 wt %, about 35 wt % to about 45 wt %, about 45 wt % to about 55 wt %, about 55 wt % to about 65 wt %, about 65 wt % to about 75 wt %, about 75 wt % to about 85 wt %, about 85 wt % to about 95 wt %, or any ranges in between. The supramolecular host molecule may also be present in the supramolecular host guest product in an amount ranging from about 5 wt % to about 95 wt %. In some examples, the supramolecular host molecule may be present in the supramolecular host guest product in an amount ranging from about 5 wt % to about 15 wt %, about 15 wt % to about 25 wt %, about 25 wt % to about 35 wt %, about 35 wt % to about 45 wt %, about 45 wt % to about 55 wt %, about 55 wt % to about 65 wt %, about 65 wt % to about 75 wt %, about 75 wt % to about 85 wt %, about 85 wt % to about 95 wt %, or any ranges in between. In other examples, the supramolecular host molecule may be present in the treatment fluid in an amount ranging from about 15 wt % to about 75 wt %. The supramolecular host molecule may also be present in the supramolecular host guest product in an amount ranging from about 15 wt % to about 75 wt %.

In some examples, the aforementioned components and compositions may be applicable to secondary and tertiary hydrocarbon recovery operations such as an injector-producer wells, waterflood wells, and enhanced oil recovery operations. Moreover, the treatment fluid described above may also be applicable to waterfloods operated in production wells with previously formed hydraulic fracture networks. In some examples, the injection pressure may be maintained below the fracture gradient for waterflood applications.

In some examples, the aforementioned components and compositions may be applicable to demulsification applications. In further examples the supramolecular host guest products may increase interfacial activity in desalters, free water knockout equipment, heater treaters, treating tanks, and other processes used for demulsification by promoting greater chemical availability at the interface in a vessel. Such vessels and processes may be used in portions of the production facilities, processing facilities, or refinery facilities. The supramolecular host guest products may also allow for increased efficacy in emulsion breaking operations. These processes may occur as tank treating processes. Supramolecular host guest products may increase the efficacy of additional refinery applications including corrosion inhibition, decoking operations, reducing damage associated with various acids. In offshore applications, the supramolecular host guest products may reduce the amount of acid required to treat and manage the water-soluble organics in the produced fluid stream.

In some examples, the aforementioned components and compositions may be applicable to breaking reverse emulsions along with water clarification applications. In further examples the supramolecular host guest products may increase interfacial activity in coalescers, floatation cells, interceptors, filtration systems and clarifiers by promoting greater chemical availability at the interface in a vessel. Such vessels and processes may be used in portions of the production facilities, processing facilities, or refinery facilities. The supramolecular host guest products may also allow for increased efficacy in emulsion breaking operations. These processes may occur as tank treating processes.

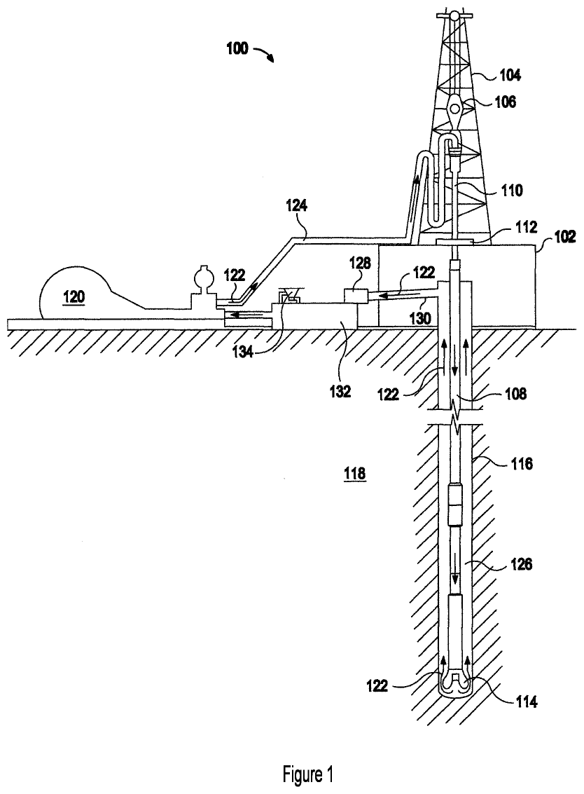

The FIG. 1 illustrates an example drilling assembly 100 in accordance with certain embodiments. It should be noted that while FIG. 1 generally depicts a land-based drilling assembly, the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 may support the drill string 108 as it is lowered through a rotary table 112. A drill bit 114 may be attached to the distal end of the drill string 108 and may be driven either by a downhole motor and/or via rotation of the drill string 108 from the well surface. The drill bit 114 may include, but is not limited to, roller cone bits, PDC bits, natural diamond bits, any hole openers, reamers, coring bits, etc. As the drill bit 114 rotates, it may create a wellbore 116 that penetrates various subterranean formations 118.

A pump 120 (e.g., a mud pump) may circulate a treatment fluid such as a drilling fluid, shown in the FIG. 1 as drilling fluid 122, through a feed pipe 124 and to the kelly 110, which conveys the drilling fluid 122 downhole through the interior of the drill string 108 and through one or more orifices in the drill bit 114. The drilling fluid may include any of the treatment fluids described herein. For example, the treatment fluid may include a base fluid and a supramolecular host guest product formulated as described above. The drilling fluid 122 may then be circulated back to the surface via an annulus 126 defined between the drill string 108 and the walls of the wellbore 116. At the surface, the recirculated or spent drilling fluid 122 may exit the annulus 126 and may be conveyed to one or more fluid processing unit(s) 128 via an interconnecting flow line 130. The fluid processing unit(s) 128 may include, but is not limited to, one or more of a screening device (e.g., shale shaker), a centrifuge, a hydrocyclone, a separator (including magnetic and electrical separators), a desilter, a desander, a separator, a filter (e.g., diatomaceous earth filters), a heat exchanger, and/or any fluid reclamation equipment. The fluid processing unit(s) 128 may further include one or more sensors, gauges, pumps, compressors, and the like used store, monitor, regulate, and/or recondition the drilling fluid.

After passing through the fluid processing unit(s) 128, a “cleaned” drilling fluid 122 may be deposited into a nearby retention pit 132 (i.e., a mud pit) for future reuse. While illustrated as being arranged at the outlet of the wellbore 116 via the annulus 126, the fluid processing unit(s) 128 may be arranged at any other location in the drilling assembly 100 to facilitate its proper function, without departing from the scope of the scope of the disclosure. One or more of the drilling fluid additives, such as a supramolecular host guest product, may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. Alternatively, the drilling fluid additives may be added to the drilling fluid 122 at any other location in the drilling assembly 100. While FIG. 1 shows only a single retention pit 132, there could be more than one retention pit 132, such as multiple retention pits 132 in series. Moreover, the retention put 132 may be representative of one or more fluid storage facilities and/or units where the drilling fluid additives may be stored, reconditioned, and/or regulated until added to the oilfield fluid 122.

While the foregoing discussion of the FIG. 1 is related drilling, the treatment fluids of the present application are not limited to drilling. For example, the treatment fluid may be utilized in operations pertaining to circulating, formation stabilization, casing, primary cementing, remedial cementing, hydraulic fracturing, acid fracturing, matrix acid jobs, logging, well testing, corrosion inhibition swabbing, water and chemical flooding for enhanced oil recovery, steam injection, production workovers, production enhancement, and the removal or inhibition of scale, salt, asphaltenes, paraffin, or other production reducing blockages.

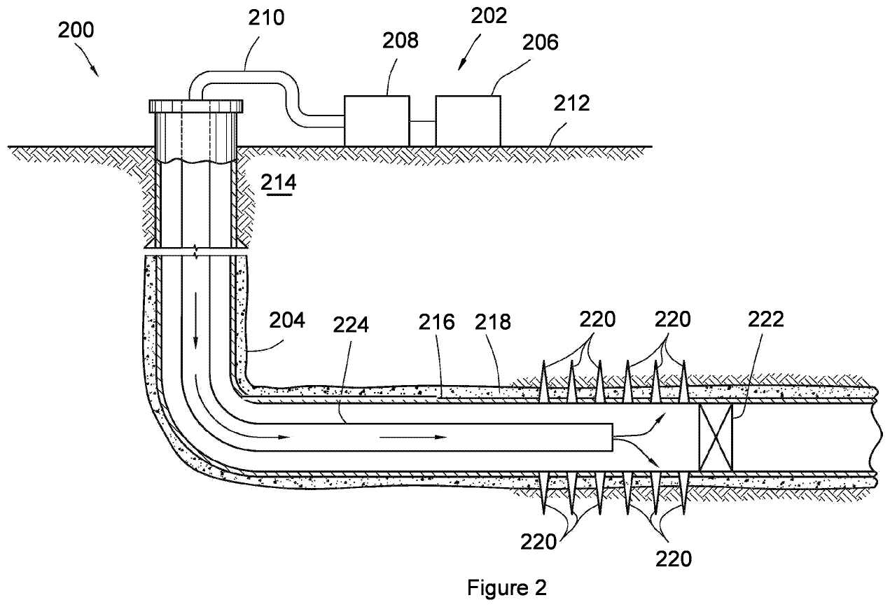

Referring now to FIG. 2, a fluid handling system 202 is illustrated in system 200 which may be utilized for operations such as hydraulic fracturing, acid fracturing, and matrix acid operations. In some examples, hydraulic fracturing may include acid fracturing. In other examples, matrix acid operations may involve bullheading or spotting acid at a zone within a subterranean formation. In some examples, acid fracturing may be achieved by pumping acid above the fracture gradient of the subterranean formation. In other examples, matrix acid operations may involve injecting acid into a wellbore at a pressure below the fracture gradient. The fluid handling system 202 may be used for preparation of a treatment fluid comprising a supramolecular host molecule and for introduction of the treatment fluid into a wellbore 204. The fluid handling system 202 may include mobile vehicles, immobile installations, skids, hoses, tubes, fluid tanks or reservoirs, pumps, valves, and/or other suitable structures and equipment. As illustrated, the fluid handling system 202 may comprise a fluid supply vessel 206, pumping equipment 208, and wellbore supply conduit 210. While not illustrated, the fluid supply vessel 206 may contain one or more components of the treatment fluid (e.g., pelletized diverting agent particulates, base fluid, etc.) in separate tanks or other containers that may be mixed at any desired time. Pumping equipment 208 may be fluidically coupled with the fluid supply vessel 206 and wellbore supply conduit 210 to communicate the treatment fluid into wellbore 204, Fluid handling system 202 may also include surface and downhole sensors (not shown) to measure pressure, rate, temperature and/or other parameters of treatment. Fluid handling system 202 may also include pump controls and/or other types of controls for starting, stopping, and/or otherwise controlling pumping as well as controls for selecting and/or otherwise controlling fluids pumped during the injection treatment. An injection control system may communicate with such equipment to monitor and control the injection of the treatment fluid. As depicted in FIG. 2, the fluid supply vessel 206 and pumping equipment 208 may be above the surface 212 while the wellbore 204 is below the surface 212. As will be appreciated by those of ordinary skill in the art, well system 200 may be configured as shown in FIG. 2 or in a different manner, and may include additional or different features as appropriate. By way of example, fluid handling system 202 may be deployed via skid equipment, marine vessel, or may be comprised of sub-sea deployed equipment.

With continued reference to FIG. 2, well system 200 may be used for introduction of a treatment fluid into wellbore 204. The treatment fluid may contain a base fluid (which may be oil- or aqueous-based) and a supramolecular host molecule, described herein. In some examples, the treatment fluid may further contain a treatment additive. Generally, wellbore 204 may include horizontal, vertical, slanted, curved, and other types of wellbore geometries and orientations. Without limitation, the treatment fluid may be applied through the wellbore 204 to subterranean formation 214 surrounding any portion of wellbore 204. As illustrated, the wellbore 204 may include a casing 216 that may be cemented (or otherwise secured) to wellbore wall by cement sheath 218. Perforations 220 allow the treatment fluid and/or other materials to flow into and out of the subterranean formation 214. A plug 222, which may be any type of plug (e.g., bridge plug, etc.) may be disposed in wellbore 204 below the perforations 220 if desired. While FIG. 2 illustrates used of treatment fluid in a cased section of wellbore 204, it should be understood that treatment fluid may also be used in portions of wellbore 204 that are not cased.

The treatment fluid comprising the supramolecular host molecule may be pumped from fluid handling system 202 down the interior of casing 216 in wellbore 204. As illustrated, well conduit 224 (e.g., coiled tubing, drill pipe, tie-back string, work string, a permanent tubular, or a non-permanent tubular etc.) may be disposed in casing 216 through which the treatment fluid may be pumped. The well conduit 224 may be the same or different than the wellbore supply conduit 210. For example, the well conduit 224 may be an extension of the wellbore supply conduit 210 into the wellbore 204 or may be tubing or other conduit that is coupled to the wellbore supply conduit 210. The treatment fluid may be allowed to flow down the interior of well conduit 224, exit the well conduit 224, and finally enter subterranean formation 214 surrounding wellbore 204 by way of perforations 220 through the casing 216 (if the wellbore is cased as in FIG. 2) and cement sheath 218. Without limitation, the treatment fluid may be introduced into subterranean formation 214 whereby one or more fractures (not shown) may be created or enhanced in subterranean formation 214. For example, the treatment fluid may be introduced into subterranean formation 214 at or above a fracturing pressure. As previously, described, the treatment fluid comprising the supramolecular host molecule may be placed into or on the face of the subterranean formation 214 after a previous treatment has been performed such that additional locations in the subterranean formation 214 may be treated. Without limitation, at least a portion of the supramolecular host molecule may be deposited in the subterranean formation 214. As previously described, the supramolecular host molecule may enhance the performance of the treatment additive included in the treatment fluid.

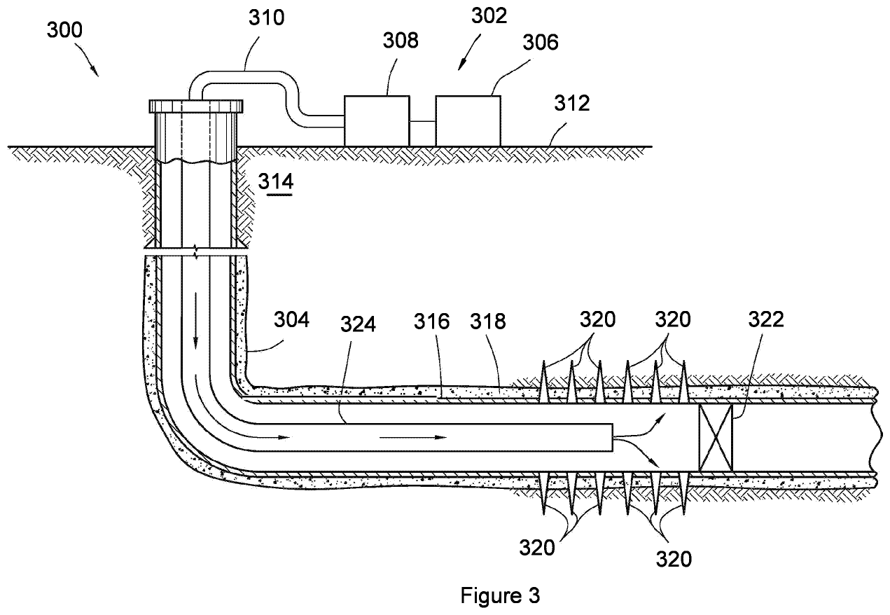

FIG. 3 illustrates an example well system 300 that may be used for preparation and delivery of a treatment fluid downhole to aid in conformance operations or water shut-off operations. It should be noted that while FIG. 3 generally depicts a land-based operation, those skilled in the art will readily recognize that the principles described herein are equally applicable to subsea operations that employ floating or sea-based platforms and rigs, without departing from the scope of the disclosure.

Referring now to FIG. 3, a fluid handling system 302 is illustrated. The fluid handling system 302 may be used for preparation of a treatment fluid comprising treated additive particles and for introduction of the treatment fluid into a wellbore 304. The fluid handling system 302 may include mobile vehicles, immobile installations, skids, hoses, tubes, fluid tanks or reservoirs, pumps, valves, and/or other suitable structures and equipment. As illustrated, the fluid handling system 302 may comprise a fluid supply vessel 306, pumping equipment 308, and wellbore supply conduit 310. While not illustrated, the fluid supply vessel 306 may contain one or more components of the treatment fluid (e.g., treated additive particles, base fluid, etc.) in separate tanks or other containers that may be mixed at any desired time. Pumping equipment 308 may be fluidically coupled with the fluid supply vessel 306 and wellbore supply conduit 310 to communicate the treatment fluid into wellbore 304, Fluid handling system 302 may also include surface and downhole sensors (not shown) to measure pressure, rate, temperature and/or other parameters of treatment. Fluid handling system 302 may also include pump controls and/or other types of controls for starting, stopping, and/or otherwise controlling pumping as well as controls for selecting and/or otherwise controlling fluids pumped during the injection treatment. An injection control system may communicate with such equipment to monitor and control the injection of the treatment fluid. As depicted in FIG. 3, the fluid supply vessel 306 and pumping equipment 308 may be above the surface 312 while the wellbore 304 is below the surface 312. As will be appreciated by those of ordinary skill in the art, well system 300 may be configured as shown in FIG. 3 or in a different manner, and may include additional or different features as appropriate. By way of example, fluid handling system 302 may be deployed via skid equipment, marine vessel, or may be comprised of sub-sea deployed equipment.

Without continued reference to FIG. 3, well system 300 may be used for introduction of a treatment fluid into wellbore 304. The treatment fluid may contain a base fluid (which may be oil- or aqueous-based) and a supramolecular host molecule, described herein. Generally, wellbore 304 may include horizontal, vertical, slanted, curved, and other types of wellbore geometries and orientations. Without limitation, the treatment fluid may be applied through the wellbore 304 to subterranean formation 314 surrounding any portion of wellbore 304. As illustrated, the wellbore 304 may include a casing 316 that may be cemented (or otherwise secured) to wellbore wall by cement sheath 318. Perforations 320 allow the treatment fluid and/or other materials to flow into and out of the subterranean formation 314. A plug 322, which may be any type of plug (e.g., bridge plug, etc.) may be disposed in wellbore 304 below the perforations 320 if desired. While FIG. 3 illustrates used of treatment fluid in a cased section of wellbore 304, it should be understood that treatment fluid may also be used in portions of wellbore 304 that are not cased.

The treatment fluid comprising a supramolecular host molecule may be pumped from fluid handling system 302 down the interior of casing 316 in wellbore 304. As illustrated, well conduit 324 (e.g., coiled tubing, drill pipe, etc.) may be disposed in casing 316 through which the treatment fluid may be pumped. The well conduit 324 may be the same or different than the wellbore supply conduit 310. For example, the well conduit 324 may be an extension of the wellbore supply conduit 310 into the wellbore 304 or may be tubing or other conduit that is coupled to the wellbore supply conduit 310. The treatment fluid may be allowed to flow down the interior of well conduit 324, exit the well conduit 324, and finally enter subterranean formation 314 surrounding wellbore 304 by way of perforations 320 through the casing 316 (if the wellbore is cased as in FIG. 3) and cement sheath 318. Without limitation, the treatment fluid may be introduced into subterranean formation 314 whereby one or more fractures (not shown) may be created or enhanced in subterranean formation 314. For example, the treatment fluid may be introduced into subterranean formation 314 at or above fracturing pressure. Without limitation, at least a portion of the supramolecular host molecules may be deposited in the subterranean formation 314. As previously described, the supramolecular host molecule may enhance the performance of the treatment additive included in the treatment fluid by at least partially reducing the permeability of certain zones in the subterranean formation.

Accordingly, the present disclosure may provide for a treatment fluid for use in wellbore operations which may facilitate concentration of the treatment fluid additives at an interface of interest such that the treatment fluid may be both more effective and may be utilized at lower concentrations. The methods/systems/compositions/tools may include any of the various features disclosed herein, including one or more of the following statements.

Statement 1. A method comprising: introducing a treatment fluid into a stream, the treatment fluid comprising: a base fluid and a supramolecular host guest product, wherein the supramolecular host guest product comprises a treatment fluid additive and a supramolecular host molecule, wherein the supramolecular host molecule is not covalently bonded to the treatment fluid additive.

Statement 2. The method of statement 1 wherein the stream is connected a wellbore, a production system, or a refinery stream.

Statement 3. The method of statements 1 or 2 wherein, the treatment fluid is used in at least one wellbore operation, production system operation, or refinery system operation selected from the group consisting of drilling, casing, primary cementing, wellbore completion, filtercake damage removal, drilling fluid damage remediation, remedial cementing, hydraulic fracturing, hydraulic refracturing, wellbore remediation, water shutoff operations, swabbing, chemical injection, chemical flooding for enhanced oil recovery, steam injection, refinery operations, fluid separation operations, production enhancement, circulating, formation stabilization, casing, primary cementing, remedial cementing, acid fracturing, matrix acid jobs, logging, well testing, corrosion inhibition, water and chemical flooding for enhanced oil recovery, steam injection, production workovers, production enhancement, and the removal or inhibition of scale, salt, asphaltenes, paraffin, decoking operations, and combinations thereof.

Statement 4. The method of any of the preceding statements wherein, the base fluid comprises at least one base fluid selected from the group consisting of oleaginous fluids, synthetic fluids, aqueous fluids, and combinations thereof.

Statement 5. The method of any of the preceding statements wherein, the supramolecular host molecule comprises at least one supramolecular host molecule selected from the group consisting of crown ethers, lariat ethers, cavitands, cryptands, rotaxanes, catenanes, and combinations thereof.

Statement 6. The method of any of the preceding statements wherein, the treatment fluid additive comprises at least one treatment fluid additive selected from the group consisting of lubricants, emulsions breakers, shale inhibitors, resins, activators, docking agents, viscosifiers, friction reducers, gelling agents, penetrating aids, non-emulsifiers, demulsifiers, flowback aids, wettability modifiers, interfacial tension suppressants, dispersants, chemical degradation suppressants, synthetic polymer breakers, polysaccharide-based polymer breakers, dissolution aids, clay control additives, fines control additives, scale prevention additives, foaming agents, defoaming agents, foam prevention additives, anti-flocculants, polar organic functional groups such as amidoamines, amines, amides, glycols, silicates, polymers (e.g.: polyacrylamide, partially hydrolyzed polyacrylamide, polyvinylpyrrolidone (“PVP”)), esters, ethers and combinations thereof.

Statement 7. The method of any of the preceding statements, further comprising: allowing the supramolecular host guest product to migrate to an interface of the treatment fluid.

Statement 8. The method of any of the preceding statements, wherein the supramolecular host molecule is included in the treatment fluid in an amount from about 15 wt % to about 75 wt % of the treatment fluid.

Statement 9. The method of any of the preceding statements, wherein the treatment fluid additive is included in the treatment fluid in an amount from about 15 wt % to about 75 wt %.

Statement 10. The method of any of the preceding statements, wherein the treatment fluid additive is included in the treatment fluid in an amount that is less than about 2% by volume.

Statement 11. The method of any of the preceding statements, wherein the supramolecular host guest product comprises at least one supramolecular host guest product selected from the group consisting of: 18 crown 6 and potassium, 15 crown 5 and sodium, 12 crown 4 and lithium, calixarene and long chain fatty amines, calixarene and quaternary ammonium cations, and combinations thereof.

Statement 12. A method comprising: introducing a treatment fluid into a drill string in a drilling operation, the treatment fluid comprising: a base fluid; and a supramolecular host guest product, wherein the supramolecular host guest product comprises: a treatment fluid additive; and a supramolecular host molecule, wherein the supramolecular host molecule is not covalently bonded to the treatment fluid additive; and extending a wellbore through a subterranean formation.

Statement 13. The method of statement 12, wherein the base fluid comprises at least one base fluid selected from the group consisting of oleaginous fluids, synthetic fluids, aqueous fluids, and combinations thereof.

Statement 14. The method of statements 12 or 13, wherein the supramolecular host molecule comprises at least one supramolecular host molecule selected from the group consisting of crown ethers, lariat ethers, cavitands, cryptands, rotaxanes, catenanes, and combinations thereof.

Statement 15. The method of any of the preceding statements 12 to 14, wherein the supramolecular host guest product comprises at least one supramolecular host guest product selected from the group consisting of: 18 crown 6 and potassium, 15 crown 5 and sodium, 12 crown 4 and lithium, calixarene and long chain fatty amines, calixarene and quaternary ammonium cations, and combinations thereof.

Statement 16. The method of any of the preceding statements 12 to 15, wherein the supramolecular host molecule is included in the treatment fluid in an amount from about 15 wt % to about 75 wt %.

Statement 17. The method of any of the preceding statements 12 to 1, wherein the treatment fluid additive is included in the treatment fluid in an amount from about 15 wt % to about 75 wt %.

Statement 18. A composition comprising: a base fluid; and a supramolecular host guest product, wherein the supramolecular host guest product comprises: at least one treatment fluid additive selected from the group consisting of amidoamines, amines, amides, glycols, silicates, polymers, esters, ethers and combinations thereof; and a supramolecular host molecule, wherein the supramolecular host molecule is not covalently bonded to the treatment fluid additive.

Statement 19. The composition of statement 18, wherein the base fluid comprises at least one base fluid selected from the group consisting of oleaginous fluids, synthetic fluids, aqueous fluids, and combinations thereof.

Statement 20. The composition of statements 18 or 19, wherein the supramolecular host molecule comprises at least one host molecular selected from the group consisting of crown ethers, lariat ethers, cavitands, cryptands, rotaxanes, catenanes, and combinations thereof.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method comprising:
introducing a treatment fluid into a stream, the treatment fluid comprising:
a base fluid and a supramolecular host guest product, wherein the supramolecular host guest product comprises a treatment fluid additive and a supramolecular host molecule, wherein the supramolecular host molecule is not covalently bonded to the treatment fluid additive.

2. The method of claim 1, wherein the stream is connected a wellbore, a production system, or a refinery stream.

3. The method of claim 1, wherein the treatment fluid is used in at least one wellbore operation, production system operation, or refinery system operation selected from the group consisting of drilling, casing, primary cementing, wellbore completion, filtercake damage removal, drilling fluid damage remediation, remedial cementing, hydraulic fracturing, hydraulic refracturing, wellbore remediation, water shutoff operations, swabbing, chemical injection, chemical flooding for enhanced oil recovery, steam injection, refinery operations, fluid separation operations, production enhancement, circulating, formation stabilization, casing, primary cementing, remedial cementing, acid fracturing, matrix acid jobs, logging, well testing, corrosion inhibition, water and chemical flooding for enhanced oil recovery, steam injection, production workovers, production enhancement, and the removal or inhibition of scale, salt, asphaltenes, paraffin, decoking operations, and combinations thereof.

4. The method of claim 1, wherein the base fluid comprises at least one base fluid selected from the group consisting of oleaginous fluids, synthetic fluids, aqueous fluids, and combinations thereof.

5. The method of claim 1, wherein the supramolecular host molecule comprises at least one supramolecular host molecule selected from the group consisting of crown ethers, lariat ethers, cavitands, cryptands, rotaxanes, catenanes, and combinations thereof.

6. The method of claim 1, wherein the treatment fluid additive comprises at least one treatment fluid additive selected from the group consisting of lubricants, emulsions breakers, shale inhibitors, resins, activators, docking agents, viscosifiers, friction reducers, gelling agents, penetrating aids, non-emulsifiers, demulsifiers, flowback aids, wettability modifiers, interfacial tension suppressants, dispersants, chemical degradation suppressants, synthetic polymer breakers, polysaccharide-based polymer breakers, dissolution aids, clay control additives, fines control additives, scale prevention additives, foaming agents, defoaming agents, foam prevention additives, anti-flocculants, polar organic functional groups such as amidoamines, amines, amides, glycols, silicates, polymers (e.g.: polyacrylamide, partially hydrolyzed polyacrylamide, polyvinylpyrrolidone (“PVP”)), esters, ethers and combinations thereof.

7. The method of claim 1 further comprising:
allowing the supramolecular host guest product to migrate to an interface of the treatment fluid.

8. The method of claim 1, wherein the supramolecular host molecule is included in the treatment fluid in an amount from about 15 wt % to about 75 wt % of the treatment fluid.

9. The method of claim 1, wherein the treatment fluid additive is included in the treatment fluid in an amount from about 15 wt % to about 75 wt %.

10. The method of claim 1, wherein the treatment fluid additive is included in the treatment fluid in an amount that is less than about 2% by volume.

11. The method of claim 1, wherein the supramolecular host guest product comprises at least one supramolecular host guest product selected from the group consisting of: 18 crown 6 and potassium, 15 crown 5 and sodium, 12 crown 4 and lithium, calixarene and long chain fatty amines, calixarene and quaternary ammonium cations, and combinations thereof.

12. A method comprising:
introducing a treatment fluid into a drill string in a drilling operation, the treatment fluid comprising:
a base fluid; and
a supramolecular host guest product, wherein the supramolecular host guest product comprises:
a treatment fluid additive; and
a supramolecular host molecule, wherein the supramolecular host molecule is not covalently bonded to the treatment fluid additive; and
extending a wellbore through a subterranean formation.

13. The method of claim 12, wherein the base fluid comprises at least one base fluid selected from the group consisting of oleaginous fluids, synthetic fluids, aqueous fluids, and combinations thereof.

14. The method of claim 12, wherein the supramolecular host molecule comprises at least one supramolecular host molecule selected from the group consisting of crown ethers, lariat ethers, cavitands, cryptands, rotaxanes, catenanes, and combinations thereof.

15. The method of claim 12, wherein the supramolecular host guest product comprises at least one supramolecular host guest product selected from the group consisting of: 18 crown 6 and potassium, 15 crown 5 and sodium, 12 crown 4 and lithium, calixarene and long chain fatty amines, calixarene and quaternary ammonium cations, and combinations thereof.

16. The method of claim 12, wherein the supramolecular host molecule is included in the treatment fluid in an amount from about 15 wt % to about 75 wt %.

17. The method of claim 12, wherein the treatment fluid additive is included in the treatment fluid in an amount from about 15 wt % to about 75 wt %.

18. A composition comprising:
a base fluid; and
a supramolecular host guest product, wherein the supramolecular host guest product comprises:
at least one treatment fluid additive selected from the group consisting of amidoamines, amines, amides, glycols, silicates, polymers, esters, ethers and combinations thereof; and
a supramolecular host molecule, wherein the supramolecular host molecule is not covalently bonded to the treatment fluid additive.

19. The composition of claim 18, wherein the base fluid comprises at least one base fluid selected from the group consisting of oleaginous fluids, synthetic fluids, aqueous fluids, and combinations thereof.

20. The composition of claim 18, wherein the supramolecular host molecule comprises at least one host molecular selected from the group consisting of crown ethers, lariat ethers, cavitands, cryptands, rotaxanes, catenanes, and combinations thereof.
